(19) United States
(12) Patent Application Publication
(10) Pub. No.: US 2008/0158157 A1
(43) Pub. Date: Jul. 3, 2008

(54) Self-Powered Wireless Computer Mouse

(76) Inventors: Hsu-Yang Chang, Yonghe City (TW); Shuo-Heng Tsai, Daliao Township (TW); Tia-Sheng Yang, Jiaosi Township (TW); Ming-Chiah Yeh, Taichung City (TW)

Correspondence Address: HDSL, 4331 STEVENS BATTLE LANE, FAIRFAX, VA, 22033, US

(21) Appl. No.: 11/618,820

(22) Filed: Dec. 30, 2006

(51) Int. Cl. G06F 3/033

(52) U.S. Cl. 345/163

(57) ABSTRACT

A self-powered wireless computer mouse utilizes the direct piezoelectric effect to generate electricity. When a user uses the mouse, a flexible flat portion and a piezoelectric element may be deformed or pressed against and the piezoelectric element may convert such mechanical stress into voltage. In addition, the computer mouse can eliminate the need for battery or other power supply means and can supply electricity by itself; therefore, the computer mouse can bring about the advancement of the computer mouse manufacturing industry.

### BACKGROUND OF THE INVENTION

1. Field of the Invention

The invention generally relates to a wireless computer mouse. More particularly, the invention relates to a self-powered wireless computer mouse that can convert the downward force of a user's hand, the horizontal motion of a mouse and the circular motion of the scroll wheel into electricity so as to power up the mouse.

2. Description of the Prior Art

Computer has been regarded as the most important invention in the 20^{th} century. Computer brought about the “fourth” industrial revolution and has changed many facets of our life. As of now, computer is used in many aspects of our life, such as work, school, research, leisure activities, etc. Also, more and more people own a PC. Computer has become an indispensable device of the modern life.

In addition to a CPU, input devices, such as keyboard and mouse, are needed for data entry.

In the past 20 years, computer mouse has evolved from mechanical mouse to optical mouse and wireless mouse. As of now, optical mouse has replaced mechanical mouse in the market and has become the preferred choice of the consuming public because it has reached technological maturity and has a reasonable price. In the last year, globally speaking, about 200 million optical mice were sold.

Though wireless optical mouse is convenient to use, the supply of electricity to it remains a problem; this is particularly true for a wireless optical mouse that is large, multifunctional and of high precision. Many people may find that their cursor suddenly becomes irresponsible and this is mainly because their mouse runs out of electricity. When this happens, people have to stop working and replace the old batteries of their mouse. This is inconvenient and there may not be any batteries readily available. In addition, the use of batteries increases the weight and size of a mouse and hence makes such mouse less popular.

The electrical requirements of a typical wireless optical mouse are 3V and 20 to 25 mA. Therefore, two type AA batteries only last for two months if such mouse is used for 4 hours per day. Therefore, how to lengthen the service life of batteries remains a problem yet to be solved for the wireless optical mouse.

To solve this problem, rechargeable batteries and a charger have been employed. However, the use of rechargeable batteries increases the weight and size of a mouse and a charger has to be additionally provided; therefore, production cost is increased. Furthermore, such rechargeable batteries have to be recharged quite often and a mouse can not be utilized while it is recharged. Whence, a mouse with rechargeable batteries and a charger remains unpopular in the market.

Another solution is the employment of a special mouse pad. Such pad can supply electricity to a mouse via electromagnetic induction. However, though the mouse is wireless, the pad does require a wire. Moreover, a user has to make sure that such pad is available or brought along with him; this makes such pad quite inconvenient.

In addition, though the service life of batteries may be lengthened, the employment of batteries is really not the best solution. The inventor of the present invention thinks that the best solution is to develop a self-powered mouse.

In the self-powered wireless computer mouse of the present invention, one or more piezoelectric elements are employed to generate electricity; therefore, the computer mouse of the present invention eliminates the need for batteries and hence the need to replace the old batteries and a user does not have to worry about when the batteries will run out of electricity.

### SUMMARY OF THE INVENTION

The present invention is to provide a self-powered wireless computer mouse in which one or more piezoelectric elements are utilized to replace the traditional power supply means. In use, the computer mouse of the present invention can convert the energy associated with the motion of a user's hand into electricity and then the electricity may be stored for the future use. In this way, the computer mouse of the present invention can eliminate the need for batteries and a user does not need to worry about when the batteries will run out of electricity. In addition, the computer mouse of the present invention can reduce the size and weight of a computer mouse.

Another, the present invention is to provide a self-powered wireless computer mouse which can eliminate the need to replace the batteries and simplify the power supply mechanism so as make a computer mouse more durable and lengthen the service life of it.

In the computer mouse of the present invention, piezoelectric effect is utilized to generate electricity. Piezoelectric effect is the property exhibited by certain crystals of generating voltage when subjected to pressure and, conversely, undergoing mechanical stress when subjected to an electric field. Piezoelectric effect is caused by the special arrangement of the atoms or molecules in a piezoelectric material. There are two types of piezoelectric effect: direct piezoelectric effect and inverse piezoelectric effect. In direct piezoelectric effect, the dipole moment in a piezoelectric material is shortened when subjected to mechanical stress and hence voltage is generated to resist this change; in other words, mechanical stress may be converted into voltage. In inverse piezoelectric effect, when a piezoelectric material is subjected to an electric field (or voltage), the dipole moment is stretched and the piezoelectric material is stretched along the direction of the electric field; electric energy may then be converted into mechanical stress. In the computer mouse of the present invention, direct piezoelectric effect is employed so that voltage may be generated by a piezoelectric material when subjected to mechanical stress. Therefore, the computer mouse of the present invention can convert the energy associated with the motion of a user's hand into electricity and then the electricity may be immediately utilized or be stored for the future use.

In the computer mouse of the present invention, a flexible flat portion is disposed on the right button or the left button, and a piezoelectric element is disposed under or above the flexible flat portion. When a user uses the mouse, the downward force of his hand may cause the deformation of the flexible flat portion and the piezoelectric element; hence, electricity may be generated. In addition, a cam may be connected with the shaft of the scroll wheel. When a user uses the scroll wheel, the cam may be set into circular motion and exert pressure on the flexible flat portion and the piezoelectric element; hence, electricity may be generated. Furthermore, a flexible bar may be disposed inside the main body of a mouse; when a user uses the mouse, the horizontal motion of the mouse may impart horizontal swinging motion to the flexible bar; therefore, two piezoelectric elements provided on the flexible bar may be deformed and hence electricity may be generated.

In the past, because a piezoelectric material can only generate a small amount of electricity, such piezoelectric material can not be used for products requiring a larger amount of electricity. However, after LED optical mouse and laser-based optical mouse were successfully developed and put on the market, the basic principles of the present invention may be employed for these types of mice because they requires a less amount of electricity. In addition, the basic principles of the present invention may be applied to other products requiring a small amount of electricity.

### BRIEF DESCRIPTION OF THE DRAWINGS

The drawings disclose several illustrative embodiments of the present invention which serve to exemplify the various advantages and objects hereof, and are as follows:

FIG. 1 is a top view of an embodiment of the computer mouse of the present invention.

FIG. 2 is a diagram schematically illustrating how electricity is generated and stored in the computer mouse of the present invention.

FIG. 3 is a side view of a first embodiment of the computer mouse of the present invention.

FIG. 4 is a side view of a second embodiment of the computer mouse of the present invention. FIG. 5 is a side view of a third embodiment of the computer mouse of the present invention.

FIG. 6 is a side view of a fourth embodiment of the computer mouse of the present invention.

FIG. 7 is a side view of a fifth embodiment of the computer mouse of the present invention.

FIG. 8 is a side view of a sixth embodiment of the computer mouse of the present invention.

FIG. 9 is a side view of a seventh embodiment of the computer mouse of the present invention.

FIG. 10 is a side view of an eighth embodiment of the computer mouse of the present invention.

### DETAILED DESCRIPTION OF THE PREFERRED EMBODIMENT

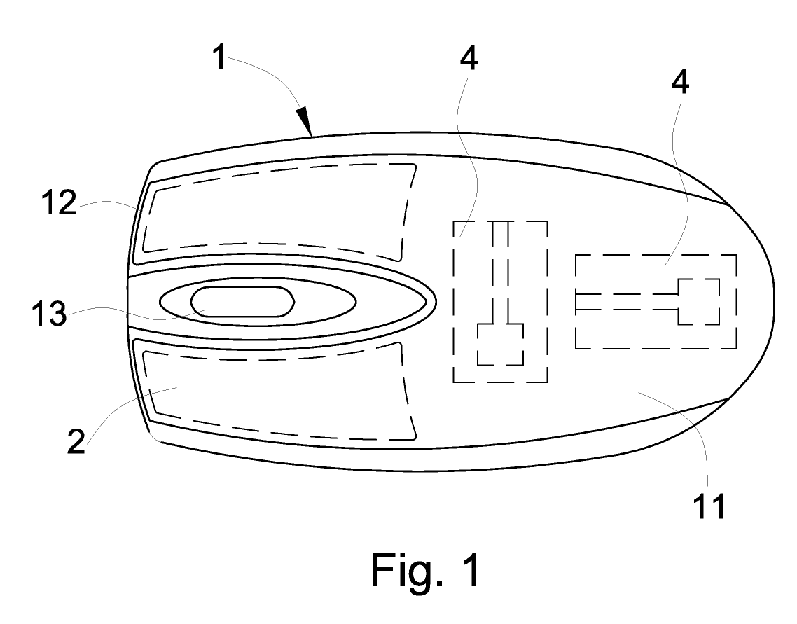

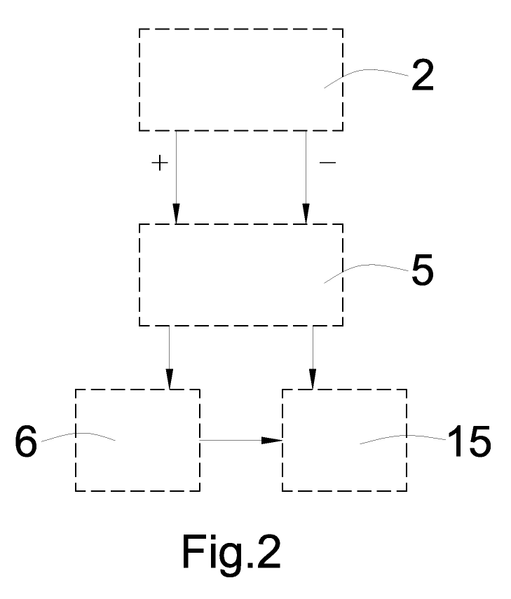

Please see FIGS. 1 and 2. The self-powered wireless computer mouse of the present invention comprises a main body 1, a conversion unit 5 and an electricity storage unit 6.

The main body 1 has a casing 11. A right button, a middle button and a left button are disposed on the top surface of the casing 11. A flexible flat portion 12 is disposed on the right button or the left button. A piezoelectric element 2 is disposed under or above the flexible flat portion 12. An optical unit 15 is disposed inside the main body 1. The optical unit 15 comprises a light generating element, a light guiding element, a circuit and a light sensor.

The conversion unit 5 is connected with the piezoelectric element 2. When the piezoelectric element 2 is subjected to mechanical stress, electrical polarization may be generated and voltage so generated may then be converted to a stable current (which is proportional to the magnitude of mechanical stress) by the conversion unit 5 (comprising a charge amplifier and an impedance changing element). Then, the current may be stored in the electricity storage unit 6 or may be immediately utilized.

The electricity storage unit 6 may receive the current converted by the conversion unit 5 and may supply its stored electricity to the mouse.

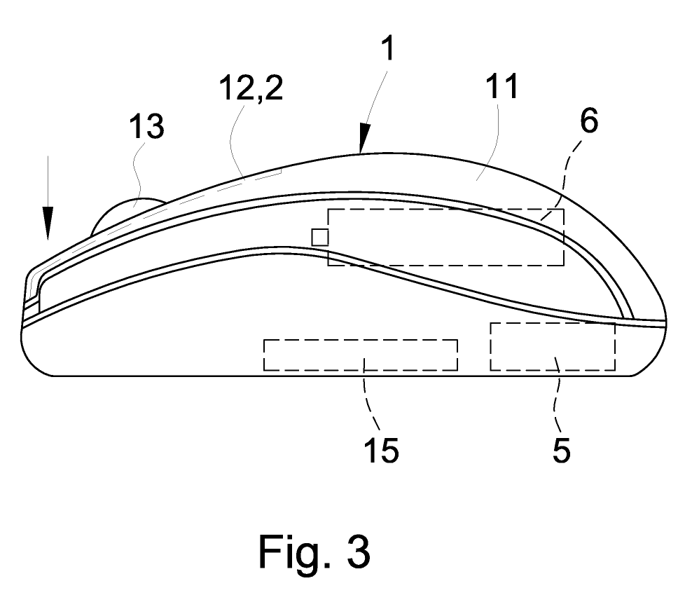

Please refer to FIG. 3. To simplify the manufacturing process, the piezoelectric element 2 and the flexible flat portion 12 may be integrally formed (with the former being formed inside the latter) when the casing 11 is formed by injection.

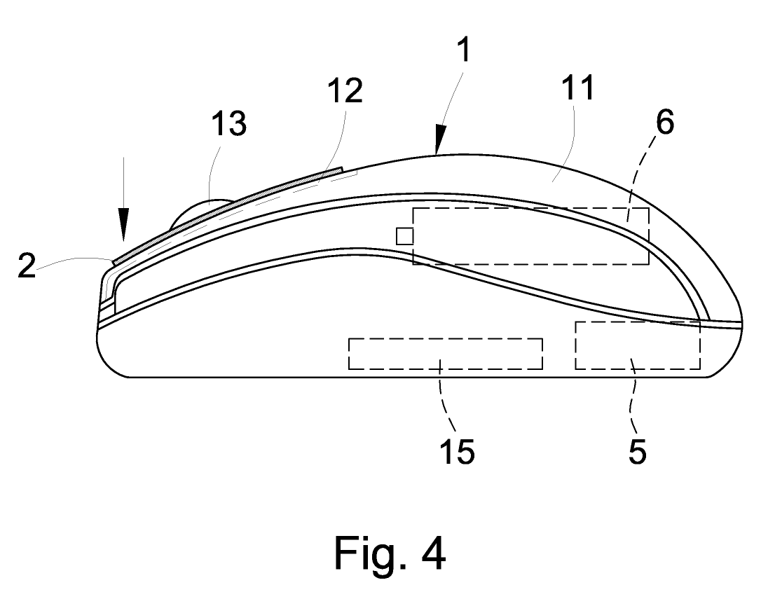

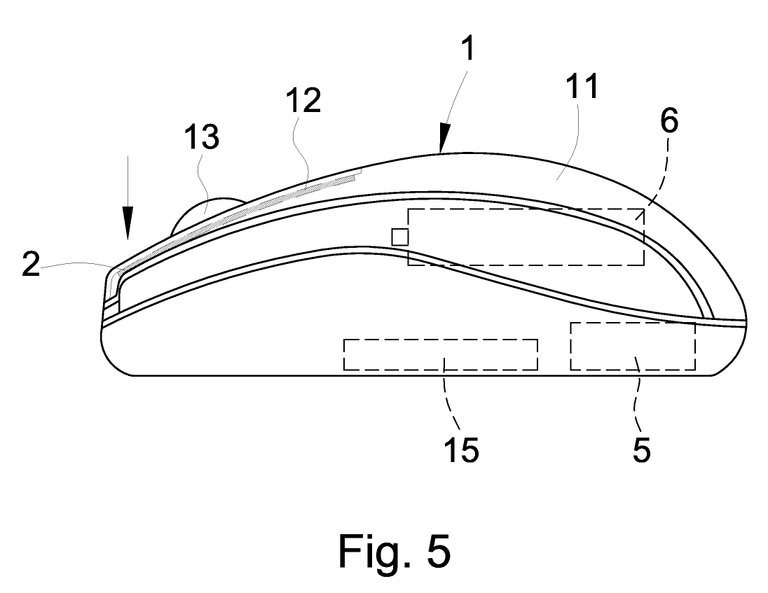

Now, please see FIG. 4. Alternatively, the casing 11 and the flexible flat portion 12 may first be formed; then, the piezoelectric element 2 is placed on top of the flexible flat portion 12.

Please refer to FIG. 5. Alternatively, the casing 11 and the flexible flat portion 12 may first be formed; then, the piezoelectric element 2 is placed under the flexible flat portion 12.

When a user uses the mouse, the downward force of his hand may cause the deformation of the flexible flat portion 12 and the piezoelectric element 2; therefore, electricity may be generated. The electricity may be immediately utilized by the mouse or be stored in the electricity storage unit 6 so that the stored electricity may be supplied to the optical unit 15 later. Also, because the electricity storage unit 6 (for example, may be a rechargeable battery) is well known in the art, no additional explanation will be given here.

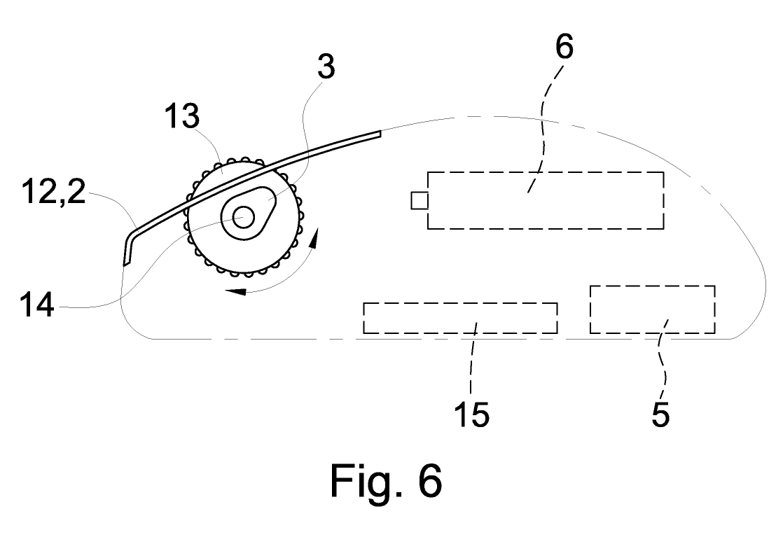

Please see FIG. 6. Many computer mice are provided with a scroll wheel 13. The scroll wheel 13 may be used to move the cursor. Because computer software has been imparted with more and more functions, the scroll wheel 13 has been widely used. Therefore, it is a good idea to utilize the motion of the scroll wheel 13 to generate electricity. A cam 3 is connected with the shaft 14 of the scroll wheel 13. The cam 3 moves along with the scroll wheel 13. In this embodiment, the aforesaid flexible flat portion 12 and piezoelectric element 2 are provided on the casing 11. Therefore, when a user uses the scroll wheel 13, the cam 3 may be set into rotational motion and exert pressure on the aforesaid flexible flat portion 12 and piezoelectric element 2; hence, electricity may be generated.

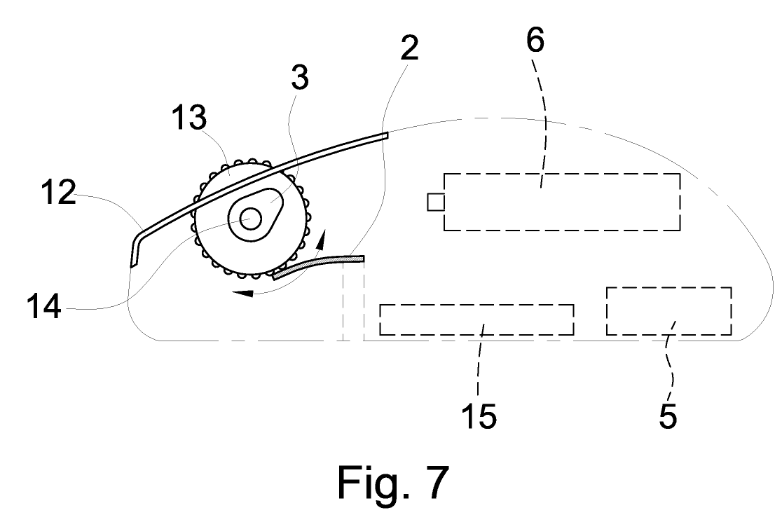

Now, please see FIG. 7. A piezoelectric element 2 may be disposed as shown in FIG. 7. A portion of the piezoelectric element 2 is in contact with a lower end of the scroll wheel 13, and another portion of the piezoelectric element 2 is fixedly connected with an inner wall of the casing 11. When a user uses the scroll wheel 13, the circular motion of the scroll wheel 13 may impart vibratory pressure to the piezoelectric element 2; hence, electricity may be generated by the piezoelectric element 2.

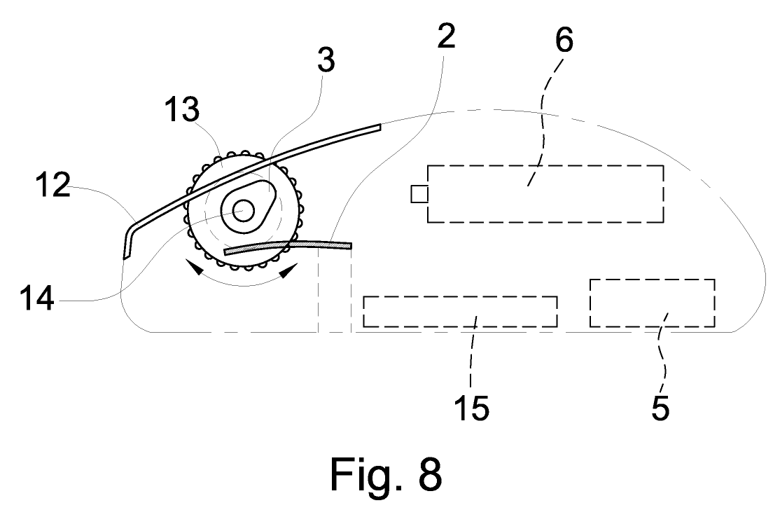

Please see FIG. 8. In this embodiment, a cam 3 is connected with the shaft 14 of the scroll wheel 13 and may move along with the scroll wheel 13. A piezoelectric element 2 is arranged under the cam 3 so that the projecting portion of the cam 3 may get in contact with the piezoelectric element 2 (in other words, the piezoelectric element 2 is tangential to the circular motion path of the projecting portion of the cam 3). Another portion of the piezoelectric element 2 is fixedly connected with an inner wall of the casing 11. When a user uses the scroll wheel 13, the circular motion of the scroll wheel 13 may impart vibratory pressure to the piezoelectric element 2; hence, electricity may be generated by the piezoelectric element 2.

Another embodiment is shown in FIGS. 1, 9 and 10. This embodiment is to harness the energy associated with the horizontal motion of a mouse. A horizontal motion piezoelectric unit 4 is disposed inside the main body 1. The horizontal motion piezoelectric unit 4 comprises a flexible bar 41 and a weight 42 which is attached to the free end of the flexible bar 41. Therefore, when a user uses the mouse, the horizontal motion of the mouse may impart horizontal swinging motion to the weight 42 and the flexible bar 41.

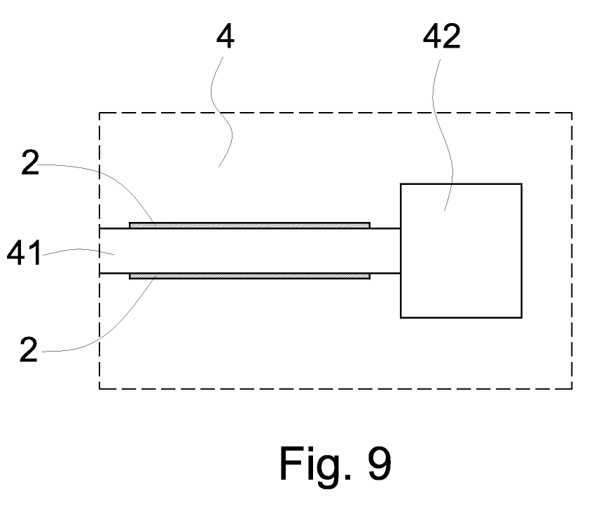

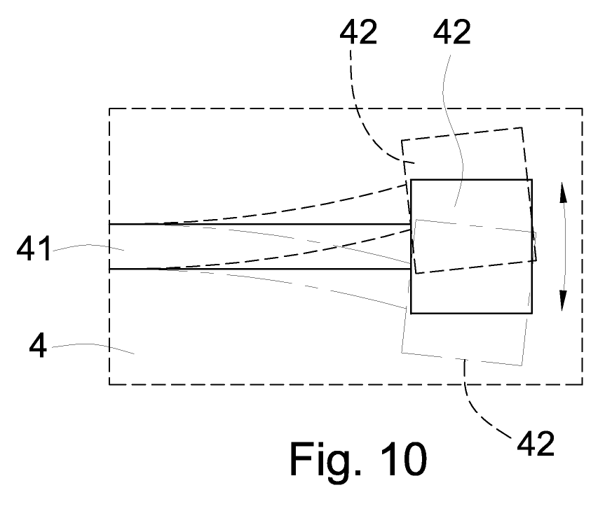

As illustrated in FIG. 9, two piezoelectric elements 2 may be provided on the flexible bar 41. Therefore, the horizontal swinging motion of the flexible bar 41 may cause the deformation of the two piezoelectric elements 2; hence, electricity may be generated. Optionally, the flexible bar 41 may be made of a piezoelectric material, as shown in FIG. 10. In addition, because the magnitude of the horizontal swinging motion of the flexible bar 41 can reach a maximal value when the horizontal motion of the mouse is perpendicular to the bar 41, two horizontal motion piezoelectric units 4 (one oriented along the length direction of the mouse and the other oriented along the width direction of the mouse) may be provided inside the main body 1; alternatively, only one of them is provided. In such way, the horizontal motion of a mouse may be used to generate electricity.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A self-powered wireless computer mouse, comprising:
a main body, having a casing, a flexible flat portion and a piezoelectric element disposed under or above the flexible flat portion;
a conversion unit, connected with the piezoelectric element to convert voltage generated by the piezoelectric element into a stable current; and
an electricity storage unit to receive the current converted by the conversion unit and supply stored electricity to the mouse.

2. The self-powered wireless computer mouse as in claim 1, wherein the flexible flat portion and the piezoelectric element are disposed on the left button or the right button fitted on the casing.

3. The self-powered wireless computer mouse as in claim 1, wherein the piezoelectric element and the flexible flat portion are integrally formed and the piezoelectric element is formed inside the flexible flat portion.

4. The self-powered wireless computer mouse as in claim 1, wherein the piezoelectric element is disposed on top of the flexible flat portion.

5. The self-powered wireless computer mouse as in claim 1, wherein the piezoelectric element is disposed under the flexible flat portion.

6. The self-powered wireless computer mouse as in claim 1, wherein a flexible bar and a weight are disposed inside the main body and the weight is attached to a free end of the flexible bar.

7. The self-powered wireless computer mouse as in claim 6, wherein the flexible bar and the weight are oriented along a length direction or a width direction of the mouse.

8. The self-powered wireless computer mouse as in claim 6, wherein a first flexible bar and a first weight are oriented along a length direction of the mouse and a second flexible bar and a second weight are oriented along a width direction of the mouse.

9. The self-powered wireless computer mouse as in claim 6, wherein two piezoelectric elements are provided on the flexible bar.

10. The self-powered wireless computer mouse as in claim 6, wherein the flexible bar is made of a piezoelectric material.

11. A self-powered wireless computer mouse, comprising:
a main body, with a flexible flat portion and a piezoelectric element fixedly connected with an inner wall of the casing, having a scroll wheel and a cam that is connected with a shaft of the scroll wheel and moves along with the scroll wheel;
a conversion unit, connected with the piezoelectric element to convert voltage generated by the piezoelectric element into a stable current; and
an electricity storage unit to receive the current converted by the conversion unit and supply stored electricity to the mouse.

12. The self-powered wireless computer mouse as in claim 11, wherein a scroll wheel is disposed on the casing and the piezoelectric element is fixedly connected with an inner wall of the casing and tangential to the circular motion path of a projecting portion of the cam; the cam moves along with the scroll wheel and, when a user uses the scroll wheel, the cam is set into rotational motion and exerts vibratory pressure on the piezoelectric element.

13. A self-powered wireless computer mouse, comprising:
a main body, having a scroll wheel and a piezoelectric element disposed inside the casing, with a portion of the piezoelectric element in contact with a lower end of the scroll wheel and another portion of the piezoelectric element fixedly connected with an inner wall of the casing so that the circular motion of the scroll wheel imparts vibratory pressure to the piezoelectric element when a user uses the scroll wheel;
a conversion unit, connected with the piezoelectric element to convert voltage generated by the piezoelectric element into a stable current; and
an electricity storage unit to receive the current converted by the conversion unit and supply stored electricity to the mouse.
